(19) United States
(12) Patent Application Publication
(10) Pub. No.: US 2018/0147880 A1
(43) Pub. Date: May 31, 2018

(54) DIFFRACTIVE DEVICE HAVING EMBEDDED LIGHT SOURCE MECHANISM

(71) Applicant: CCL Secure Pty Ltd, Craigieburn, Victoria (AU)

(72) Inventor: Robert Arthur Lee, Craigieburn, Victoria (AU)

(73) Assignee: CCL Secure Pty Ltd, Craigieburn, Victoria (AU)

(21) Appl. No.: 15/575,944

(22) PCT Filed: May 20, 2016
(86) PCT No.: PCT/AU2016/050384

§ 371 Date: Nov. 21, 2017

(30) Foreign Application Priority Data
May 21, 2015 (AU) 2015100671
May 21, 2015 (AU) 2015901866

(51) Int. Cl. B42D 25/328; B42D 25/351; B42D 25/425; B42D 25/378; G02B 27/44; G02B 27/42

(52) U.S. Cl. CPC B42D 25/328; B42D 25/351; B42D 25/425; B42D 25/29; G02B 27/44; G02B 27/4205; B42D 25/378

(57) ABSTRACT

An optical device comprising an at least substantially transparent substrate having a first side comprising a source layer having an arrangement of source elements and a second side comprising an Optically Variable Device (OVD) layer having a corresponding arrangement of diffractive elements, wherein each source element is configured to, upon illumination of the first side, provide an embedded light source for an associated diffraction element, and wherein the diffractive elements are configured for producing an optical effect observable when the diffractive elements are viewed by a viewer, such as the naked eye, upon illumination by the source elements.

### FIELD OF THE INVENTION

The invention generally relates to the field of optical devices, in particular those used to enhance the counterfeiting resistance of documents.

### BACKGROUND TO THE INVENTION

Optically variable devices, such as holograms, diffractive optical elements, microlens devices, interference pigment device, etc. are known to improve the resistance of documents to counterfeiting. Typically, the optically variable device is formed on to or affixed to the document, and provides protection against traditional copying techniques such as photocopying as such techniques are unable to accurately reproduce the variable appearance of the device.

Optically variable devices have been developed which are more difficult to counterfeit using more advanced techniques, in response to improvements made by counterfeiters in reproducing, or at least satisfactorily imitating, existing optically variable devices.

In order for an optically variable device to be useful in providing protection, users of documents to which the device is affixed should be readily able to identify the device, and the optical effect that it provides. Typically, desirable characteristics of optically variable devices include brightness, memorability, ease of use, etc.

Improvements to such devices are therefore required, in order to continuously increase deterrence to counterfeiting.

### SUMMARY OF THE INVENTION

Existing diffractive based devices, such as diffractive optical elements (DOE), create optically variable effects through diffractive interaction with incident light. The optically variable effect is often strongly dependent on the nature of the incident light source, for example whether it is a diffuse light, a point light source, and the shape of the light source.

In light of this, according to an aspect of the present invention, there is provided an optical device comprising an at least substantially transparent substrate having a first side comprising a source layer having an arrangement of source elements and a second side comprising an Optically Variable Device (OVD) layer having a corresponding arrangement of diffractive elements, wherein each source element is configured to, upon illumination of the first side by an external light source, provide an embedded light source being a light source which provides light for an associated diffraction element substantially independent of the external light source, and wherein the diffractive elements are configured for producing an optical effect observable when the diffractive elements are viewed by a viewer, such as the naked eye, upon illumination by the source elements, wherein each diffraction element is configured in accordance with the shape of its associated source element.

Preferably, either or both of: a) the source elements define images which are varied or fixed between the source elements; and b) the surface relief of the diffractive elements is varied between the diffractive elements, such that the observed image or images appears to; change in magnification; move; change form; change brightness; change contrast; and/or change hue as the angle of view is changed.

Each source element may define a source image and each diffractive element may define a diffractive focussing element, preferably a circular or cylindrical zone plate type diffractive element, configured such as to provide a magnified and/or displaced projection of the source image of the associated source element.

Typically, the substrate comprises a characteristic thickness, and wherein the surface relief of each diffractive element is determined in part by the characteristic thickness.

Each diffractive element is preferably uniquely associated with one source element.

Preferably, each source element has at least one linear dimension less than a spacing between the source element and its associated diffractive element, preferably approximately half the spacing.

According to another aspect of the present invention, there is provided a document, preferably a security document, comprising the optical device of the previous embodiment.

Preferably, the document comprises a transparent document substrate, a region of which corresponding to the same substrate as the optical device, preferably wherein the document also comprises opacifying layers on each side of the document substrate, each absent in overlapping regions thereby defining a window in which the optical device is located. Alternatively, the optical device may be formed separately to the document and affixed to the document in a window region, wherein the window is either a transparent portion of the document or corresponds to a removed portion of the document.

According to yet another aspect of the present invention, there is provided a method of manufacturing the optical device of the first aspect, including the steps of: preparing a shim having an inverse profile to a required OVD layer profile; determining a printing pattern corresponding to a required source layer; applying to a surface of a transparent substrate a radiation curable ink; embossing the radiation curable ink with the shim, and curing the radiation curable ink, thereby forming the diffraction layer; and printing onto an opposing surface of the substrate the printing pattern, preferably in register with the surface profile of the diffraction layer.

The step of embossing and the step of printing are preferably performed substantially simultaneously.

Optionally, the transparent substrate includes opacifying layers located on each surface, the opacifying layers absent in the region of the radiation curable ink thereby defining a window comprising the optical device.

Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The diffraction gratings and optically variable devices described herein may also have application in other products, such as packaging.

Security Device or Feature

As used herein the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET), biaxially-oriented polypropylene (BOPP); or a composite material of two or more materials, such as a laminate of paper and at least one plastic material, or of two or more polymeric materials.

Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

Opacifying Layers

One or more opacifying layers may be applied to a transparent substrate to increase the opacity of the security document. An opacifying layer is such that L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

Refractive Index n

The refractive index of a medium n is the ratio of the speed of light in vacuum to the speed of light in the medium. The refractive index n₂ of a lens determines the amount by which light rays reaching the lens surface will be refracted, according to Snell's law:

n₁·sin(θ₁)=n₂·sin(θ₂)

where θ₁ is the angle between an incident ray and the normal at the point of incidence at the lens surface, θ₂ is the angle between the refracted ray and the normal at the point of incidence, and n₁ is the refractive index of air (as an approximation n₁ may be taken to be 1).

Embossable Radiation Curable Ink

The term embossable radiation curable ink used herein refers to any ink, lacquer or other coating which may be applied to the substrate in a printing process, and which can be embossed while soft to form a relief structure and cured by radiation to fix the embossed relief structure. The curing process does not take place before the radiation curable ink is embossed, but it is possible for the curing process to take place either after embossing or at substantially the same time as the embossing step. The radiation curable ink is preferably curable by ultraviolet (UV) radiation. Alternatively, the radiation curable ink may be cured by other forms of radiation, such as electron beams or X-rays.

The radiation curable ink is preferably a transparent or translucent ink formed from a clear resin material. Such a transparent or translucent ink is particularly suitable for printing light-transmissive security elements such as sub-wavelength gratings, transmissive diffractive gratings and lens structures.

In one particularly preferred embodiment, the transparent or translucent ink preferably comprises an acrylic based UV curable clear embossable lacquer or coating.

Such UV curable lacquers can be obtained from various manufacturers, including Kingfisher Ink Limited, product ultraviolet type UVF-203 or similar. Alternatively, the radiation curable embossable coatings may be based on other compounds, eg nitro-cellulose.

The radiation curable inks and lacquers used herein have been found to be particularly suitable for embossing microstructures, including diffractive structures such as diffraction gratings and holograms, and microlenses and lens arrays. However, they may also be embossed with larger relief structures, such as non-diffractive optically variable devices.

The ink is preferably embossed and cured by ultraviolet (UV) radiation at substantially the same time. In a particularly preferred embodiment, the radiation curable ink is applied and embossed at substantially the same time in a Gravure printing process.

Preferably, in order to be suitable for Gravure printing, the radiation curable ink has a viscosity falling substantially in the range from about 20 to about 175 centipoise, and more preferably from about 30 to about 150 centipoise. The viscosity may be determined by measuring the time to drain the lacquer from a Zahn Cup #2. A sample which drains in 20 seconds has a viscosity of 30 centipoise, and a sample which drains in 63 seconds has a viscosity of 150 centipoise.

With some polymeric substrates, it may be necessary to apply an intermediate layer to the substrate before the radiation curable ink is applied to improve the adhesion of the embossed structure formed by the ink to the substrate. The intermediate layer preferably comprises a primer layer, and more preferably the primer layer includes a polyethylene imine. The primer layer may also include a cross-linker, for example a multi-functional isocyanate. Examples of other primers suitable for use in the invention include: hydroxyl terminated polymers; hydroxyl terminated polyester based co-polymers; cross-linked or uncross-linked hydroxylated acrylates; polyurethanes; and UV curing anionic or cationic acrylates. Examples of suitable cross-linkers include: isocyanates; polyaziridines; zirconium complexes; aluminium acetylacetone; melamines; and carbodi-imides.

Metallic Nanoparticle Ink

As used herein, the term metallic nanoparticle ink refers to an ink having metallic particles of an average size of less than one micron.

### BRIEF DESCRIPTION OF THE DRAWINGS

Embodiments of the invention will now be described with reference to the accompanying drawings. It is to be appreciated that the embodiments are given by way of illustration only and the invention is not limited by this illustration. In the drawings:

FIGS. 1a and 1b show documents having optical devices according to different embodiments of the invention;

FIG. 2 shows a simplified representation of an optical device according to the present invention;

FIG. 3 shows a source layer and a OVD layer according to an embodiment;

FIG. 4 shows the interaction between a light source, a grating structure, and an eye;

FIG. 5 shows a source element configured as a slit and a corresponding grating of a diffraction element;

FIG. 6 shows an external light source illuminating a source element, and a diffraction element configured to provide a magnified equivalent to the image of the source element; and

FIG. 7 shows a method for manufacturing an optical device.

### DESCRIPTION OF PREFERRED EMBODIMENT

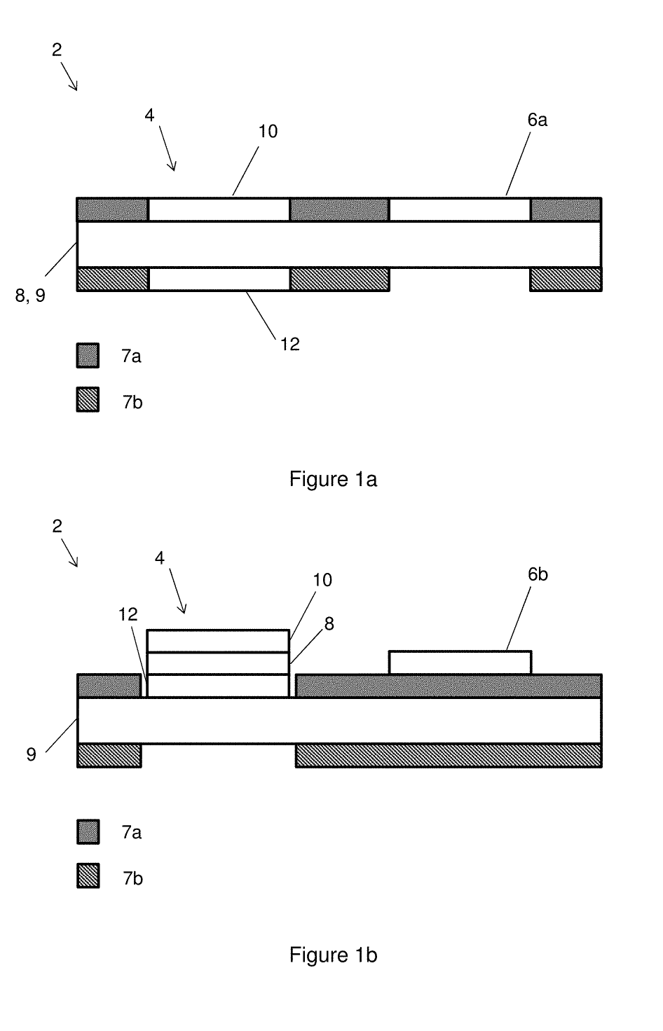

FIGS. 1a and 1b each show a document 2 having an optical device 4 according to embodiments of the invention. The optical device 4 comprises a transparent (or at least substantially transparent) substrate 8. The document 2 also comprises a substrate (herein, document substrate 9). In the embodiment of FIG. 1a, the two substrates 8, 9 are the same, that is, the optical device 4 and the document 2 share the same substrate 8, 9. In the embodiment of FIG. 1b, the document substrate 9 is different to the substrate 8 of the optical device 4.

In each case, the document 2 includes first and second opacifying layers 7a, 7b. The opacifying layers 7a, 7b act to reduce or eliminate the transparency of the document 2 in the regions in which the layers 7a, 7b are present. In the embodiments shown, both opacifying layers 7a, 7b are not present in the area of the optical device 4, thereby causing the optical device 4 to be located within a window region of the document 2.

It is also possible for the document 2 to be inherently opaque (or substantially opaque), for example where the document substrate 9 is paper or a paper composite material. In this case, the opacifying layers 7a, 7b are not necessarily required. The optical device 4 in this case is still located in a window region of the document 2, which can be achieved using knowing methods such as forming the optical device 4 as a foil, and applying the foil to a cut-out area of the opaque document substrate 9.

The optical device 4 typically provides a security function, that is, the optical device 4 acts to decrease the susceptibility of the document 2 to counterfeiting. The optical device 4 can be referred to as a “security device” or “security token” when used for this purpose. A document 2 requiring protection to counterfeiting is often referred to as a “security document”.

FIGS. 1a and 1b also show further security features 6 (6a in FIG. 1a, 6b in FIG. 1b), which can assist in reducing the susceptibility of the document 2 to counterfeiting in combination with the optical device 4. In FIG. 1a, the further security feature 6a is implemented in a window region of the document 2, whereas in FIG. 1b the further security feature 6b is implemented in an opaque (i.e. non-window) region of the document 2. The illustrated arrangements are simply examples, and generally the document 2 can include one or more security features 6, each implemented in a window, half-window, or opaque region of the document 2. Example further security features 6 include: optically variable devices such as diffractive optical elements, Kinograms®, microlens based features, holograms, etc; watermark images; fine print; etc.

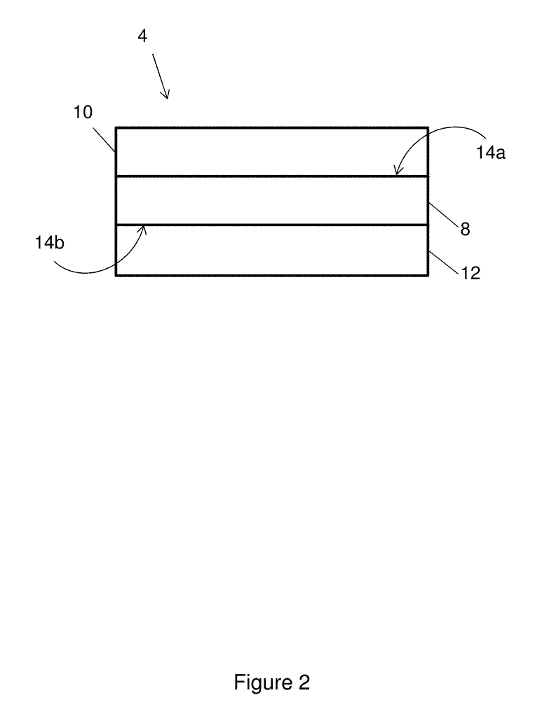

As shown in FIGS. 1a and 1b, and in more detail in FIG. 2, the optical device 4 generally includes a substrate 8 having on a first side 16a a source layer 10 and on a second side 16b an OVD layer 12 opposite the source layer 10.

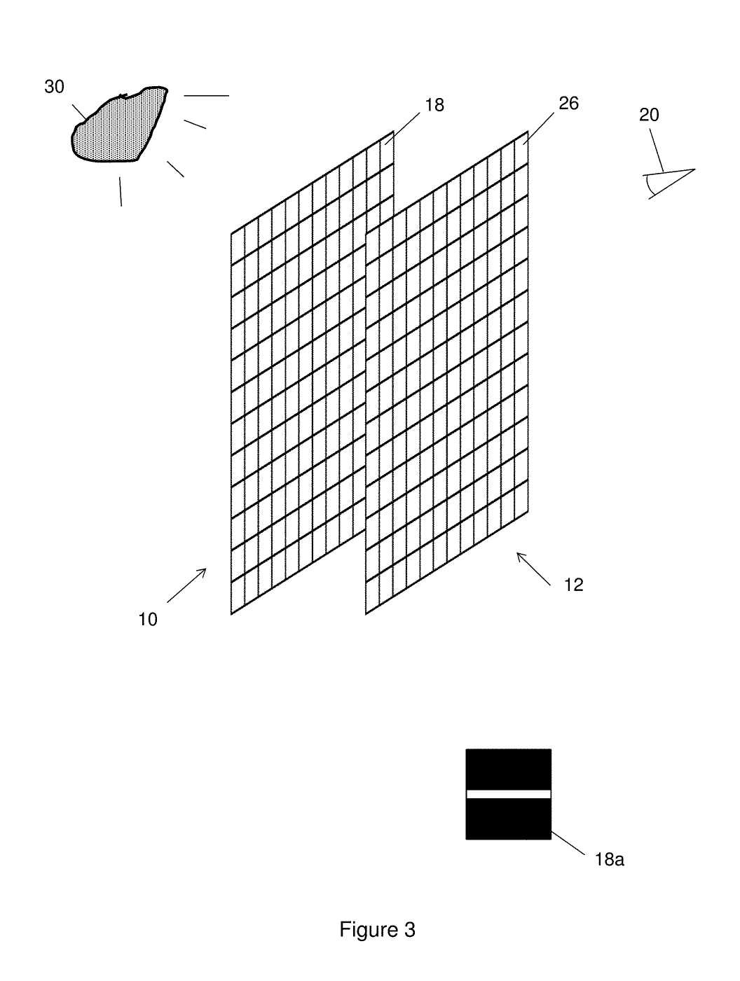

FIG. 3 shows the source layer 10 and OVD layer 12 in further detail. The source layer 10 comprises an arrangement of source elements 18. The source elements 18 typically correspond to a pixelated printed source pattern, that is, they are created by selectively printing onto areas of the source layer 10 and each source element 18 constitutes a “pixel” of the source pattern. The arrangement can be as shown; that is, a regular square array. According to an implementation, the arrangement is selected such that the source elements 18 are arranged in any repeating manner, for example by arranging according to one of the five 2-dimensional Bravais lattices. In an alternative implementation, the arrangement of source elements 10 is not required to be repeating.

Each source element 18 of the source layer 10 defines an image which is defined by a transparent portion and an opaque portion. Typically, the opaque portion defines at least a border of the image, such that the entire transparent portion of the source element 10 is within the border. The source elements 10 are typically created using a printing process, such as rotogravure, silkscreen, intaglio, etc., where ink is only applied in the opaque portions. In this way, the source elements 18 define transparent images.

FIG. 3 also shows a specific example of a source element 18, being source element 18a which has an image in the form of a transparent line or slit surrounded by an opaque printed border.

In an embodiment, each source element 18 is identical. Therefore, the arrangement of source elements 18 constitutes an arrangement of identical printed source pixels. In another embodiment, not shown, the source layer 10 comprises different source elements 18, that is, the source layer 10 includes at least two different images. Having different source elements allows for a change in depiction as the viewing position is changed.

It is understood that the images defined by the source elements 18 can be selected from very simple concepts, for example a line or dot image, or more complicated concepts, such as characters, symbols, or depictions.

An external light source 30 is located such as to illuminate the source layer 10. The external light source 30 is of arbitrary shape, for example point source, fluorescent tube, uniform cloudy sky, etc. Furthermore, the external light source can illuminate the source layer 10 from an arbitrary angle or direction.

Each source element 18 transmits the light incident from the light source only through the non-opaque regions of the source element 18. The overall effect is that each source element 18 acts as an embedded light source with a predefined shape corresponding to the image of the source element, for example the slit shown in FIG. 3.

The substrate 8 is transparent, allowing the light incident onto each source element 18 to propagate from the first side 14a of the substrate 8 to the second side 14b. The substrate 8 acts as a spacer for the source layer 10 and the OVD layer 12. Typically, the substrate 8 is sourced from a bulk material, and will have a characteristic thickness. For example, biaxially oriented polypropylene material used in polymer banknotes typically has a thickness between 70 and 100 μm.

Still in reference to FIG. 3, the OVD layer 12 includes an arrangement of diffractive elements 26. The diffractive elements 26 typically correspond to a pixelated OVD microstructure. In essence, each diffractive element 18 can constitute a pixel of a larger diffractive OVD structure. The diffractive elements 26 are configured for viewing by a viewer 20, typically the naked eye.

Each diffractive element 26 is associated with a source element 18. Typically, each diffractive element 26 is uniquely associated with a source element 18 and vice versa (as shown in FIG. 3), in that each diffractive element 26 is illuminated by its associated source element 18. Alternatives are however envisaged, for example, each source element 18 may be uniquely associated with a fixed number (greater than one) of diffractive elements 26, or each diffractive element 26 may be uniquely associated with a fixed number (greater than one) of source elements 18. For example, a source element 18 may be arranged to provide an artificial light source for four diffractive elements 26, or one diffractive element 26 may be configured to interact with four separate artificial light sources, each corresponding to a different source element 18.

As the source elements 18 provide an embedded light source with a consistent shape that is independent, or at least relatively independent, of the external light source 30, it is possible to design each diffractive element 26 in accordance with the particular image of the associated source element 18. Each diffractive element 26 has a surface relief configured for producing an optically variable image when the device is observed by the naked eye; the image being optically variable in that it varies in form and/or brightness with changing angle of view of the device. Optionally, the surface relief of each diffractive element 26 will be configured specifically for that diffractive element 26, though there may ultimately be diffractive elements 26 having the same surface relief.

In general, it can be preferred that the linear dimensions of the source elements 18 are less than the spacing between source elements 18 and diffractive elements 26. Typically, the source elements 18 will have linear dimensions roughly half the spacing between the source elements 18 and the diffractive elements 26. For example, when utilised as a security device on a banknote, the spacing between the source elements 18 and the diffractive elements 26 is approximately 70 microns. In this example, each source element 18 has two linear dimensions of 30 microns.

Reference is made to R. A. Lee, “Generalized curvilinear diffraction gratings I. Image diffraction patterns”, OPTICA ACTA, 1983, vol. 30, no. 3, 267-289 (herein referred to as “GCDG1”), which describes a general theory for curvilinear diffraction gratings illuminated by an arbitrarily extended diffuse light source. Each source element 18 is effectively an arbitrarily extended diffuse light source within the context of GCDG1.

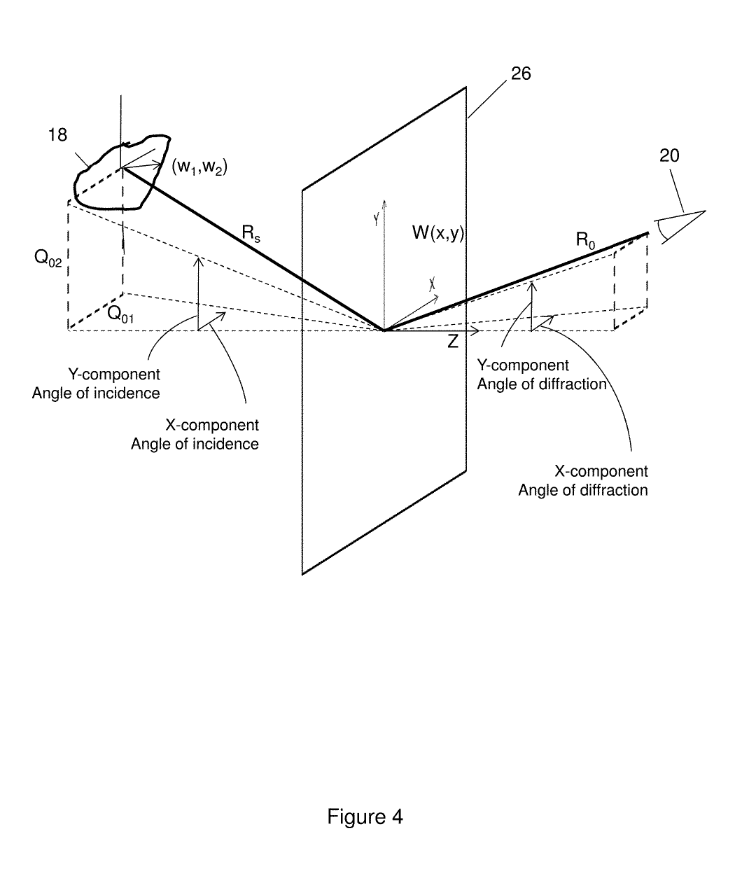

Referring now to FIG. 4, the grating function for a particular diffractive element 26 is given by W(x, y), and the grating grooves of the diffractive element 26 are defined by the indicial equation of the form W(x, y)=n, where “n” is the groove index number (i.e., n=1, 2, 3, . . . ). The figure shows a generalised relationship between source element 18 (that is, the light source), diffraction element 26, and the viewer 20. As described in R. A. Lee, “Generalised Curvilinear Diffraction Gratings II”, OPTICA ACTA 1983, vol. 30, no. 3, 291-303 (herein referred to as “GCDG2”), W(x, y) can also be regarded as the contour map of an abstract phase surface transferred to a planar light wave as it passes through or is diffracted from the grating groove pattern W(x, y).

The geometric optics diffraction grating ray equations for the above situation are given by:

$$\begin{matrix}{p}_{1} + {w}_{1} + {Q}_{01} = \frac{x}{G} - λ h \frac{\partial W}{\partial x} & ( 1 ) \\ {p}_{1} + {w}_{1} + {Q}_{01} = \frac{y}{G} - λ h \frac{\partial W}{\partial y} & ( 2 )\end{matrix}$$

where (Q₀₁, Q₀₂) are the coordinates of the centre of the light source coordinate system (i.e., the centre of the associated source element 18), located at a distance Rₛ from the centre of the grating, as shown in FIG. 4. The coordinates (w₁, w₂) are the coordinates of a particular point on the light source, while (p₁, p₂) are the coordinates of an eye (or other viewer) observation point located a distance R₀ from the centre of the grating, also as shown in FIG. 4. The parameter G is defined by G⁻¹=R₀⁻¹+Rₛ⁻¹, while h is the diffraction order number and λ is the wavelength of the incident light.

In GCDG1 and GCDG2 it was shown that the observed fringe pattern (that is, the set of (x, y) points in the grating plane that are observed to diffract light to the eye at a particular angle of view) can be described by an equation of the form:

S_{(w1,w2)})(w₁+Q₀₁,w₂+Q₀₂)=0 (3)

which defines the angular shape of the embedded light source in terms of individual points within the light source represented by (w₁, w₂) which in turn are defined with respect to the centre point of the light source defined by (Q₀₁, Q₀₂). The observed or perceived illuminated points on the grating are calculated by substituting the grating ray equations of equations (1) and (2) into equation (3).

Consider the example of a generalised diffraction grating observed at an angle normal to the plane of the grating and illuminated by an extended incoherent polychromatic source in the form of a very thin slit illuminated by a polychromatic external light source such as shown in FIG. 3, oriented in a direction parallel to the x-axis (as defined in FIG. 4) of the grating. Applying equation (2) in this situation results in the expression:

$${p}_{2} + {Q}_{02} = \frac{y}{G} - λ h \frac{\partial W}{\partial y} \qquad ( 4 )$$

where w₂=0 as the slit can be approximated by an infinitely thin line. The coordinate w₁ does not enter into the calculation because the slit is also approximated by a line of infinite length so that equation (1) applied equally to all points in the x direction. Q₀₂ defines the angle of the source with respect to the y direction and h is the diffraction order number and takes values of h=±1, ±2, ±3, etc, although usually only the first, and possibly second, orders need to be included in the calculation for those gratings whose brightness or diffraction efficiency drops off rapidly with increasing order number.

For the particular case of a zone plate type OVD where W=A(x²+y²), with “A” being a constant, equation (4) gives

$${p}_{2} + {Q}_{02} = y ( \frac{1}{G} - 2 λ hA ) or y = ( {p}_{2} + {Q}_{02} ) / ( \frac{1}{G} - 2 λ hA ) ,$$

which describes a series of straight lines (one for each value of “h”) parallel to the source line.

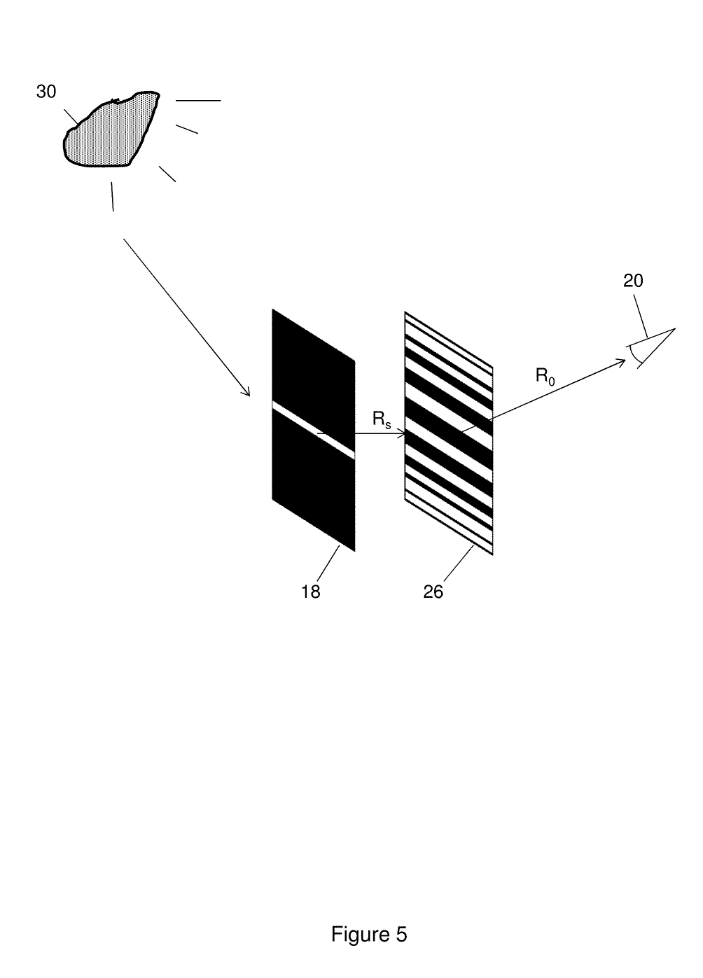

Referring now to FIG. 5, a detailed view of the interaction between a single source element 18 and diffractive element 26 is shown. Here, the source element 18 is in the form of the printed slit of FIG. 3. Shown spaced apart and opposite the source element 18 is the diffractive element 26, being a series of straight lines parallel to the printed slit (source line) of source element 18.

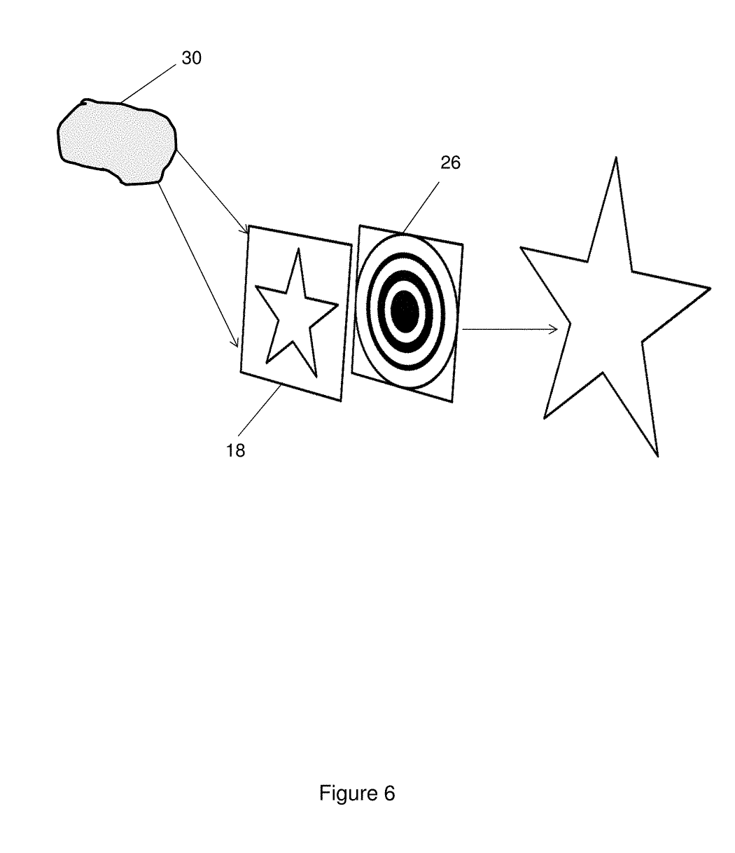

A particular embodiment is shown in FIG. 6. Here, the diffractive elements 26 are configured as diffractive lenses, that is, they act in a similar manner to a concave or convex lens. When coupled to a source element 18 defining an arbitrary shape (in this case, a star), the viewer 20 perceives the same shape (that is, a star) when viewing the diffraction element 26.

For a diffractive element 26 configured as a diffractive lens, the grating function can be of the form W(x, y)=A(x²+y²)+Bx+Cy, where “A”, “B”, and “C” are constants with “A” defining the focussing characteristic and “B and “C” defining off-axis focal points of the diffractive element 26. For example, if “B” and “B” are both zero then the diffractive element 26 would be of a circular type diffractive lens as shown in FIG. 6. Equations (5) and (6) are obtained by substituting this expression for the grating function into equations (1) and (2):

$$\begin{matrix}{p}_{1} + {w}_{1} + {Q}_{01} = x ( \frac{1}{G} - 2 A λ h ) + B & ( 5 ) \\ {p}_{1} + {w}_{2} + {Q}_{02} = y ( \frac{1}{G} - 2 A λ h ) + C & ( 6 )\end{matrix}$$

and substituting these into equation (3) provides:

S_{(w1,w2)}(x(G⁻¹−2Aλh)+B−p₁,y(G⁻¹−2Aλh)+C−p₂)=0 (7)

where the calculation is applied at every (w₁, w₂) point within the embedded light source. Note that the source equation which was originally a function of (w₁, w₂) (see equation (3)) is now a function of (x, y) with a linear relation between points (w₁, w₂) and (x, y).

The result shows that a diffractive lens array where each diffractive element 26 is described by a grating function of the form W(x, y)=A(x²+y²)+Bx+Cy produces an observed diffraction fringe pattern having the same shape as the image defined by its associated source element 18. The only difference being that the diffractive fringe pattern is a magnified and/or displaced version of the image (magnified according to the parameter “A” and displaced according to the parameters “B” and “C”).

The degree of magnification can be calculated by considering two points (w₁, w₂) and (w′₁, w′₂) on a source element 18 and observed through the corresponding diffractive element 26 at point (p₁, p₂). Substituting into equations (5) and (6) gives the observed image points occurring at (x, y) and (x′, y′). The degree of magnification can then be found by:

$$M = \frac{( {x}^{′} - x )}{( {w}_{1}^{′} - {w}_{1} )} = \frac{( {y}^{′} - y )}{( {w}_{2}^{′} - {w}_{2} )} = \frac{G}{( 1 - 2 A λ hG )} \qquad ( 8 )$$

As G⁻¹=R₀⁻¹+Rₛ⁻¹ and that the observed distance Rₒ is much larger than the thickness of the document substrate Rₛ, it is possible to simplify the magnification to:

$$M = \frac{1}{( {R}_{s} - 2 A λ h )} \qquad ( 9 )$$

This relationship allows for suitable selection of the lens focus parameter “A” depending on the desired magnification for a particular substrate thickness, wavelength, and image characteristics required.

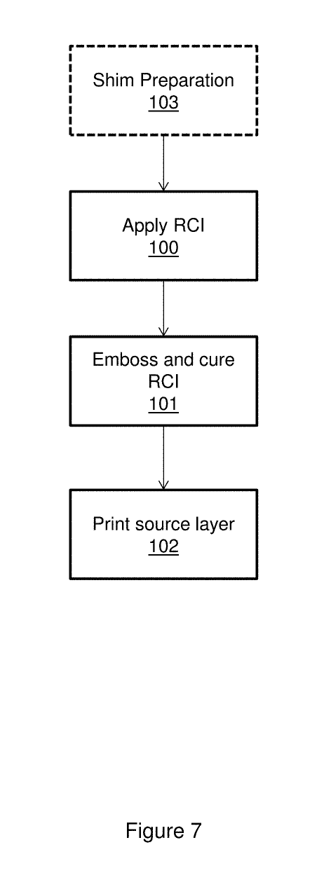

The optical device 4 disclosed herein can be manufactured according to the method shown in FIG. 7. A transparent substrate is provided, such as a biaxially oriented polypropylene substrate, and a radiation curable ink is applied through a printing process to one side of the substrate, at RCI step 100. The radiation curable ink is then embossed with a shim and cured at embossing step 101. The shim has a surface profile the opposite to the intended surface profile of the OVD layer 12.

Printing step 102 is undertaken simultaneously with, before, or after, embossing step 101. Printing step 102 corresponds to the creation of the source layer 10 through printing of an opaque (or substantially opaque) ink to the opposite side of the substrate, the opaque ink absent in areas defining the source images. Typically, it is necessary to ensure registration between the diffraction elements 26 and the source elements 24, which may be achieved using known methods.

As will be clear, the method of FIG. 7 requires that a shim has previously been created, for example utilising known e-beam techniques, and that a suitable printing pattern is been formulated for creating the source elements 24. FIG. 7 shows the optional shim preparation step 103. Typically, the design of both the shim and the printing pattern is assisted by a computer. Usually, the intended source images 18 are determined as well as the intended projected image and projection direction. From this, the required grating profile for each diffraction element 26 can be determined utilising computational methods implementing the relationships described herein.

Further modifications and improvements may be incorporated without departing from the scope of the invention.

The claims defining the invention are as follows:

1. An optical device comprising an at least substantially transparent substrate having a first side comprising a source layer having an arrangement of source elements and a second side comprising an Optically Variable Device (OVD) layer having a corresponding arrangement of diffractive elements, wherein each source element is configured to, upon illumination of the first side by an external light source, provide an embedded light source being a light source which provides light for an associated diffraction element substantially independent of the external light source, and wherein the diffractive elements are configured for producing an optical effect observable when the diffractive elements are viewed by a viewer, such as the naked eye, upon illumination by the source elements, wherein each diffraction element is configured in accordance with the shape of its associated source element.

2. An optical device as claimed in claim 1, wherein either or both of:
a) the source elements define images which are varied between the source elements; and
b) the surface relief of the diffractive elements is varied between the diffractive elements,
such that the observed image appears to change in magnification and/or move and/or change form as the angle of view is changed.

3. An optical device as claimed in claim 2, wherein only the diffractive elements are varied.

4. An optical device as claimed in claim 2, wherein only the source elements are varied.

5. An optical device as claimed in claim 1, wherein each source element defines a source image and wherein each diffractive element defines a diffractive focussing element, preferably a circular or cylindrical zone plate type diffractive element, configured such as to provide a magnified and/or displaced projection of the source image of the associated source element.

6. An optical device as claimed in claim 1, wherein the substrate comprises a characteristic thickness, and wherein the surface relief of each diffractive element is determined in part by the characteristic thickness.

7. An optical device as claimed in claim 1, wherein each diffractive element is uniquely associated with one source element.

8. An optical device as claimed in claim 1, wherein each source element has at least one linear dimension less than a spacing between the source element and its associated diffractive element, preferably approximately half the spacing.

9. A document, preferably a security document, comprising the optical device of claim 1.

10. A document as claimed in claim 9, wherein the document comprises a transparent document substrate, a region of which corresponding to the same substrate as the optical device, preferably wherein the document also comprises opacifying layers on each side of the document substrate, each absent in overlapping regions thereby defining a window in which the optical device is located.

11. A document as claimed in claim 9, wherein the optical device is formed separately to the document and affixed to the document in a window region, wherein the window is either a transparent portion of the document or corresponds to a removed portion of the document.

12. A method of manufacturing the optical device of claim 1, including the steps of:
preparing a shim having an inverse profile to a required OVD layer profile;
determining a printing pattern corresponding to a required source layer;
applying to a surface of a transparent substrate a radiation curable ink;
embossing the radiation curable ink with the shim, and curing the radiation curable ink, thereby forming the diffraction layer; and
printing onto an opposing surface of the substrate the printing pattern, preferably in register with the surface profile of the diffraction layer.

13. A method as claimed in claim 12, wherein the step of embossing and the step of printing are performed substantially simultaneously.

14. A method as claimed in claim 12, wherein the transparent substrate includes opacifying layers located on each surface, the opacifying layers absent in the region of the radiation curable ink thereby defining a window comprising the optical device.
